(19) United States
(12) Patent Application Publication
(10) Pub. No.: US 2025/0233136 A1
(43) Pub. Date: Jul. 17, 2025

(54) BATTERY

(71) Applicant: TOYOTA JIDOSHA KABUSHIKI KAISHA, Toyota-shi (JP)

(72) Inventor: Ryosuke FURUYA, Gotemba-shi (JP)

(73) Assignee: TOYOTA JIDOSHA KABUSHIKI KAISHA, Toyota-shi (JP)

(21) Appl. No.: 18/934,741

(22) Filed: Nov. 1, 2024

(30) Foreign Application Priority Data
Jan. 16, 2024 (JP) 2024-004544

(51) Int. Cl. H01M 4/38; H01M 4/02

(52) U.S. Cl. CPC H01M 4/386; H01M 2004/021; H01M 2004/027

(57) ABSTRACT

A battery including a positive electrode current collector, a positive electrode layer, an electrolyte layer, a negative electrode layer, and a negative electrode current collector in that order, wherein the negative electrode layer includes a first layer disposed on the side of the electrolyte layer in a thickness direction and a second layer disposed on the side of the negative electrode current collector in the thickness direction relative to the first layer, wherein the first layer and the second layer each contain a Si-based active material and a solid electrolyte as a negative electrode active material, wherein the value obtained by subtracting the ion conductivity of the second layer from the ion conductivity of the first layer is 0.08 mS/cm or more, and wherein the percentage of the solid electrolyte in the first layer is 47.5 vol % or less.

### CROSS-REFERENCE TO RELATED APPLICATION

This application claims priority to Japanese Patent Application No. 2024-004544 filed on Jan. 16, 2024, incorporated herein by reference in its entirety.

### BACKGROUND

### 1. Technical Field

The present disclosure relates to a battery.

### 2. Description of Related Art

Various techniques regarding batteries such as those disclosed in Japanese Unexamined Patent Application Publication No. 2023-044620 (JP 2023-044620 A), Japanese Unexamined Patent Application Publication No. 2015-225855 (JP 2015-225855 A), Japanese Unexamined Patent Application Publication No. 2012-104270 (JP 2012-104270 A), and Japanese Unexamined Patent Application Publication No. 2011-124028 (JP 2011-124028 A) have been proposed.

### SUMMARY

In conventional batteries using electrodes containing solid electrolytes, there is room for improvement in terms of the capacity retention rate (cycle characteristics) during charging and discharging cycles. Increasing the content of the solid electrolyte in the electrode in order to improve the capacity retention rate causes a problem of a decrease in the energy density of the battery.

The present disclosure has been made in view of the above circumstances, and a main object of the present disclosure is to provide a battery that can improve the energy density and capacity retention rate.

Specifically, the present disclosure includes the following aspects.

<1> A battery including a positive electrode current collector, a positive electrode layer, an electrolyte layer, a negative electrode layer, and a negative electrode current collector in that order,
wherein the negative electrode layer includes a first layer disposed on the side of the electrolyte layer in a thickness direction and a second layer disposed on the side of the negative electrode current collector in the thickness direction relative to the first layer,
wherein the first layer and the second layer each contain a Si-based active material and a solid electrolyte as a negative electrode active material,
wherein the value obtained by subtracting the ion conductivity of the second layer from the ion conductivity of the first layer is 0.08 mS/cm or more, and
wherein the percentage of the solid electrolyte in the first layer is 47.5 vol % or less.

<2> The battery according to <1>,
wherein the percentage of the solid electrolyte in the first layer is 35.3 vol % or more.

<3> The battery according to <1> or <2>,
wherein the Si-based active material is porous.

<4> The battery according to any one of <1> to <3>,
wherein the volume ratio (SE/AM) of the solid electrolyte to the negative electrode active material in the first layer is larger than the volume ratio (SE/AM) of the solid electrolyte to the negative electrode active material in the second layer.

<5> The battery according to any one of <1> to <4>,
wherein the thickness of the first layer is 7 to 25 μm, and
wherein the thickness of the negative electrode layer is 40 μm or more.

According to the present disclosure, it is possible to provide a battery that can improve the energy density and capacity retention rate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view showing an example of a battery of the present disclosure.

### DETAILED DESCRIPTION OF EMBODIMENTS

Embodiments of the present disclosure will be described below. Here, components other than those particularly mentioned in this specification that are necessary for implementation of the present disclosure (for example, a battery that does not characterize the present disclosure) can be recognized by those skilled in the art as design matters based on the related art in the field. The present disclosure can be implemented based on content disclosed in this specification and common general technical knowledge in the field.

In the present disclosure, unless otherwise specified, the average particle size of particles is a median diameter (D50) value, which is a particle size at a cumulative value of 50% in the volume-based particle size distribution measured by laser diffraction/scattering particle size distribution measurement.

In the present disclosure, there is provided a battery including a positive electrode current collector, a positive electrode layer, an electrolyte layer, a negative electrode layer, and a negative electrode current collector in that order,
wherein the negative electrode layer includes a first layer disposed on the side of the electrolyte layer in a thickness direction and a second layer disposed on the side of the negative electrode current collector in the thickness direction relative to the first layer,
wherein the first layer and the second layer each contain a Si-based active material and a solid electrolyte as a negative electrode active material,
wherein the value obtained by subtracting the ion conductivity of the second layer from the ion conductivity of the first layer is 0.08 mS/cm or more, and
wherein the percentage of the solid electrolyte in the first layer is 47.5 vol % or less.

In the present disclosure, when the negative electrode layer is made to have a multi-layer structure, and the ion conductivity of the negative electrode layer on the side of the electrolyte layer is set to be higher than that on the side of the negative electrode current collector, a decrease in the amount of the negative electrode active material in the negative electrode layer is minimized, the entire negative electrode layer is uniformly charged, expansion of the negative electrode layer near the interface with the electrolyte layer is inhibited, and thus the cycle characteristics can be improved.

The battery of the present disclosure includes a positive electrode current collector, a positive electrode layer, an electrolyte layer, a negative electrode layer, and a negative electrode current collector in that order.

### Positive Electrode

The positive electrode includes a positive electrode layer and a positive electrode current collector.

### Positive Electrode Layer

The positive electrode layer contains a positive electrode active material, and as necessary, may contain a solid electrolyte, a conductive material, a binder and the like.

Examples of positive electrode active materials lithium nickel cobalt aluminum oxide (NCA), LiCoO₂, LiNiₓCo₁₋ₓO₂ (0<x<1), LiNi_{1/3}Co_{1/3}Mn_{1/3}O₂, LiMnO₂, LiMn₂O₄, LiNiO₂, LiVO₂, Li—Mn spinels substituted with different elements, lithium titanate, lithium metal phosphate, LiCoN, Li₂SiO₃, and Li₄SiO₄. Examples of Li—Mn spinels substituted with different elements include LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄. Examples of lithium titanate include Li₄Ti₅O₁₂. Examples of lithium metal phosphates include LiFePO₄, LiMnPO₄, LiCoPO₄, and LiNiPO₄.

The shape of the positive electrode active material is not particularly limited, and may be a particle shape (positive electrode active material particle). The average particle size of the positive electrode active material particles is not particularly limited, and may be 1 nm to 100 μm.

A coating layer containing a Li-ion conducting oxide may be formed on the surface of the positive electrode active material. This is because the reaction between the positive electrode active material and the solid electrolyte can be restricted.

Examples of Li-ion conducting oxides include LiNbO₃, Li₄Ti₅O₁₂, and Li₃PO₄. The thickness of the coating layer is, for example, 0.1 nm or more, and may be 1 nm or more. On the other hand, the thickness of the coating layer is, for example, 100 nm or less, and may be 20 nm or less. The coverage of the coating layer on the surface of the positive electrode active material is, for example, 70% or more, and may be 90% or more.

As the conductive material, known materials can be used, and examples thereof include carbon materials and metal particles. Examples of carbon materials include acetylene black (AB), furnace black, VGCF, carbon nanotubes, multi-walled carbon nanotubes (MWCNT), and carbon nanofibers. Among these, in consideration of electron conductivity, at least one selected from the group consisting of VGCF, carbon nanotubes, multi-walled carbon nanotubes, and carbon nanofibers may be used. Examples of metal particles include particles of Ni, Cu, Fe, and SUS.

The content of the conductive material in the positive electrode layer is not particularly limited.

As the solid electrolyte, solid electrolytes that can be contained in the electrolyte layer may be exemplified.

The content of the solid electrolyte in the positive electrode layer is not particularly limited, and may be, for example, in a range of 1 mass % to 80 mass % based on a total mass of 100 mass % of the positive electrode layer.

Examples of binders include rubber-based binders and fluoride-based binders. Examples of rubber-based binders include butadiene rubber, acrylonitrile butadiene rubber (ABR), hydrogenated butadiene rubber, styrene butadiene rubber (SBR), hydrogenated styrene butadiene rubber, nitrile butadiene rubber, hydrogenated nitrile butadiene rubber, and ethylene propylene rubber. Examples of fluoride-based binders include polyvinylidene fluoride (PVDF), polyvinylidene fluoride-polyhexafluoropropylene copolymers (PVDF-HFP), polytetrafluoroethylene, and fluororubber.

The content of the binder in the positive electrode layer is not particularly limited.

The thickness of the positive electrode layer is not particularly limited.

The positive electrode layer can be formed by a conventionally known method.

For example, a positive electrode active material, and as necessary, other components are added to a solvent and stirred to prepare a positive electrode slurry, and the positive electrode slurry is applied onto one surface of a support such as a positive electrode current collector and dried to obtain a positive electrode layer.

Examples of solvents include butyl acetate, butyl butyrate, heptane, and N-methyl-2-pyrrolidone.

The method of applying a positive electrode slurry onto one surface of a support such as a positive electrode current collector is not particularly limited, and examples thereof include a doctor blade method, a metal mask printing method, an electrostatic coating method, a dip coating method, a spray coating method, a roll coating method, a gravure coating method, and a screen printing method.

As the support, one having self-supporting properties can be appropriately selected and used, and the support is not particularly limited, and for example, a metal foil such as Cu and Al can be used.

### Positive Electrode Current Collector

As the positive electrode current collector, a known metal that can be used as a current collector for a battery can be used. Examples of such metals include metal materials containing one, two or more elements selected from the group consisting of Cu, Ni, Al, V, Au, Pt, Mg, Fe, Ti, Co, Cr, Zn, Ge, and In. Examples of positive electrode current collectors include SUS, aluminum, nickel, iron, titanium and carbon.

The form of the positive electrode current collector is not particularly limited, and various forms such as a foil form and a mesh form can be used.

### Negative Electrode

The negative electrode includes a negative electrode layer and a negative electrode current collector.

### Negative Electrode Layer

The negative electrode layer includes a first layer disposed on the side of the electrolyte layer in the thickness direction and a second layer disposed on the side of the negative electrode current collector in the thickness direction relative to the first layer.

The first layer and the second layer each contain a Si-based active material and a solid electrolyte as a negative electrode active material, and as necessary, may contain at least one of a conductive material and a binder.

The value obtained by subtracting the ion conductivity of the second layer from the ion conductivity of the first layer may be 0.08 mS/cm or more, and the upper limit is not particularly limited.

The percentage of the solid electrolyte in the first layer may be 47.5 vol % or less, and the lower limit may be 35.3 vol % or more.

The volume ratio (SE/AM) of the solid electrolyte (SE) to the negative electrode active material (AM) in the first layer may be larger than the volume ratio (SE/AM) of the solid electrolyte to the negative electrode active material in the second layer.

The volume ratio (SE/AM) of the solid electrolyte to the negative electrode active material in the first layer may be 1 or more and 1.855 or less.

The thickness of the first layer may be 7 to 25 μm.

The thickness of the second layer may be 15 μm or more.

The thickness of the negative electrode layer may be 40 μm or more and 1,000 μm or less.

Examples of negative electrode active materials include a Si-based active material. Examples of Si-based active materials include elemental Si, Si alloys, and silicon oxide. The Si-based active material may be a porous Si. The Si-based active material may be a diamond-type crystal Si, a clathrate Si, an amorphous Si or the like and may be a porous clathrate Si. The clathrate Si may be clathrate type I or clathrate type II.

The negative electrode active material may be negative electrode active material particles. The average particle size of the negative electrode active material particles is not particularly limited, and may be 1 nm to 100 μm.

Examples of conductive materials, solid electrolytes and binders used in the negative electrode layer include those exemplified as the conductive materials, solid electrolytes and binders that can be contained in the positive electrode layer.

### Negative Electrode Current Collector

The material of the negative electrode current collector may be a material that is not alloyed with Li, and examples thereof include SUS, copper and nickel. Examples of the form of the negative electrode current collector include a foil form and a plate form. The shape of the negative electrode current collector in a plan view is not particularly limited, and examples thereof include a circular shape, an elliptical shape, a rectangular shape and any polygonal shape. In addition, the thickness of the negative electrode current collector varies depending on the shape, and may be, for example, in a range of 1 μm to 50 μm or in a range of 5 μm to 20 μm.

### Electrolyte Layer

The electrolyte layer may be a liquid electrolyte layer containing an electrolytic solution as an electrolyte or a solid electrolyte layer containing a solid electrolyte as an electrolyte.

The electrolyte layer may include a separator for retaining an electrolytic solution and preventing the positive electrode layer and the negative electrode layer from coming into contact with each other and the like. The thickness of the electrolyte layer is not particularly limited, and may be, for example, 0.1 μm or more or 1 μm or more, and 2 mm or less or 1 mm or less.

Examples of separators include those made of resins such as polyethylene (PE), polypropylene (PP), polyester and polyamide. The separator may have a single-layer structure or a multi-layer structure. Examples of separators having a multi-layer structure include a separator having a two-layer structure of PE/PP and a separator having a three-layer structure of PP/PE/PP or PE/PP/PE. The separator may be made of a nonwoven fabric such as a cellulose nonwoven fabric, a resin nonwoven fabric, or a glass fiber nonwoven fabric.

Examples of solid electrolytes include inorganic solid electrolytes such as sulfide solid electrolytes, oxide solid electrolytes, hydride solid electrolytes, halide solid electrolytes, and nitride solid electrolytes, and organic polymer electrolytes such as polymer electrolytes. In order to prevent the positive electrode layer and the negative electrode layer from peeling off from the solid electrolyte layer and further reduce the resistance of the solid battery, a relatively soft sulfide solid electrolyte may be used as the solid electrolyte. The solid electrolytes may be used alone or two or more thereof may be used in combination. In addition, when two or more types of solid electrolytes are used, the two or more types of solid electrolytes may be mixed, or two or more layers of the solid electrolyte may be formed to form a multi-layer structure.

The proportion of the solid electrolyte in the solid electrolyte layer is not particularly limited, and is, for example, 50 mass % or more, and may be 99 mass % or less.

Examples of sulfide solid electrolytes include solid electrolytes containing, for example, elemental Li, elements A, and elemental S. The elements A are at least one of P, As, Sb, Si, Ge, Sn, B, Al, Ga, and In. The sulfide solid electrolyte may further contain at least one of elemental O and a halogen element. Examples of halogen elements (X) include elemental F, elemental Cl, elemental Br, and elemental I. The sulfide solid electrolyte may be glass (amorphous), glass ceramics, or crystalline. When the sulfide solid electrolyte is crystalline, the sulfide solid electrolyte has a crystal phase. Examples of crystal phases include a Thio-LISICON type crystal phase, an LGPS type crystal phase, and an argyrodite type crystal phase. Examples of sulfide solid electrolytes include Li₂S—P₂S₅, LiI—Li₂S—P₂S₅, LiI—LiBr—Li₂S—P₂S₅, Li₂S—SiS₂, Li₂S—GeS₂, and Li₂S—P₂S₅—GeS₂. Here, the above reference to “Li₂S—P₂S₅” means a material obtained using a raw material composition containing Li₂S and P₂S₅, and the same applies to other description. The molar ratio of the elements in the sulfide solid electrolyte can be controlled by adjusting the content of each element in the raw material. In addition, the molar ratio and compositions of the elements in the sulfide solid electrolyte can be measured through, for example, ICP emission spectroscopy.

Examples of oxide solid electrolytes include solid electrolytes containing elemental Li, elements Z (Z is at least one of Nb, B, Al, Si, P, Ti, Zr, Mo, W, and S), and elemental O. Examples of oxide solid electrolytes include Li₂O—B₂O₃—P₂O₅, Li₂O—SiO₂, Li₂O—B₂O₃, Li_{1.3}Al_{0.3}Ti_{0.7}(PO₄)₃, Li₅La₃Ta₂O₁₂, Li₇La₃Zr₂O₁₂, Li₆BaLa₂Ta₂O₁₂, Li_{3.6}Si_{0.6}P_{0.4}O₄, Li₄SiO₄, Li₃PO₄, and Li₃₊ₓPO₄₋ₓNₓ (1≤x≤3).

The hydride solid electrolyte has, for example, Li and a complex anion containing hydrogen. Examples of complex anions include (BH₄)⁻, (NH₂)⁻, (AlH₄)⁻, and (AlH₆)³⁻.

Examples of halogenated solid electrolytes include LiF, LiCl, LiBr, LiI, and LiI—Al₂O₃.

Examples of nitrogenated solid electrolytes include Li₃N.

As the binder, binders that can be contained in the positive electrode layer described above may be exemplified.

When the solid electrolyte layer contains a binder, the content of the binder with respect to a total amount of the solid electrolyte layer may be 0 parts by mass to 3 parts by mass.

The solid electrolyte may be solid electrolyte particles.

The average particle size (D50) of the solid electrolyte particles is not particularly limited, but may be 0.1 μm or more, 0.5 μm or more, 100 μm or less, or 10 μm or less in order to reduce the battery resistance.

The solid electrolyte layer can be formed, by for example, the following method.

The solid electrolyte layer may be formed by preparing a solid electrolyte slurry containing a solid electrolyte, a binder and a solvent and applying the solid electrolyte slurry onto a release film.

As the solvent, solvents that can be used to prepare the positive electrode slurry described above may be exemplified.

As necessary, the battery includes an exterior body in which a positive electrode layer, a negative electrode layer, a solid electrolyte layer and the like are accommodated.

The material of the exterior body is not particularly limited as long as it is stable in an electrolyte, and examples thereof include resins such as aluminum, polypropylene, polyethylene, and acrylic resins.

Examples of shapes of batteries include a coin shape, a laminate shape, a cylindrical shape, and a rectangular shape.

The battery of the present disclosure may be a liquid battery or a solid battery.

Here in the present disclosure, the solid battery refers to a battery containing a solid electrolyte. The solid battery may be a semi-solid-state battery that is a solid battery containing a solid electrolyte and a liquid material or may be an all-solid-state battery that is a solid battery containing no liquid material.

When a set of a positive electrode, an electrolyte layer and a negative electrode is defined as a power generation unit, the battery may include only one power generation unit or may include two or more power generation units. When the battery has two or more power generation units, these power generation units may be connected in series or connected in parallel.

The battery may be a primary battery or a secondary battery. Applications of batteries include power sources for vehicles, for example, hybrid electric vehicles (HEV), plug-in hybrid electric vehicles (PHEV), battery electric vehicles (BEV), gasoline vehicles, and diesel vehicles. Among these, the battery may be used as a power source for driving hybrid electric vehicles (HEV), plug-in hybrid electric vehicles (PHEV) or battery electric vehicles (BEV). In addition, the battery may be used as a power source for moving objects (for example, trains, ships, and aircrafts) other than vehicles, and may be used as a power source for electrical products such as information processing devices.

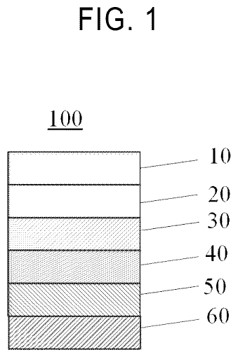

FIG. 1 is a schematic cross-sectional view showing an example of a battery of the present disclosure.

A battery 100 includes a positive electrode current collector 10, a positive electrode layer 20, an electrolyte layer 30, a first layer 40 of a negative electrode layer, a second layer 50 of a negative electrode layer, and a negative electrode current collector 60 in that order.

### Examples 1 to 10 and Comparative Examples 6 to 8

### Preparation of Negative Electrode Slurry

A porous Si-based active material as a negative electrode active material, a sulfide solid electrolyte as a solid electrolyte, a conductive material (0.4 mg), SBR (20 mg) as a binder, and diisobutyl ketone (1,765 mg) as a solvent were mixed and the mixture was dispersed for 10 minutes using ultrasonic waves with an amplitude of 40 μm and a frequency of 20 kHz to prepare a negative electrode slurry.

### Preparation of First Layer

The slurry prepared above was applied onto an Al foil and dried on a hot plate to prepare a first layer. Table 1 shows vol % of the solid electrolyte, vol % of the Si-based active material, SE/AM, and the thickness of the first layers of Examples 1 to 10 and Comparative Examples 6 to 8.

### Preparation of Second Layer

The slurry prepared above was applied to a roughened Ni foil and dried on a hot plate to prepare a second layer. Table 1 shows vol % of the solid electrolyte, vol % of the Si-based active material, SE/AM, and the thickness of the second layers of Examples 1 to 10 and Comparative Examples 6 to 8.

### Preparation of Negative Electrode

The first layer on the Al foil and the second layer on the Ni foil were placed face to each other and roll-pressed with a linear pressure of 0.25 t/cm, the first layer was transferred to the second layer on the side of the Ni foil, and the Al foil was peeled off to prepare a negative electrode including a negative electrode layer with a two-layer structure and a Ni foil as a negative electrode current collector.

### Preparation of Solid Electrolyte Layer

A sulfide solid electrolyte (0.4 g) as a solid electrolyte and a heptane solution containing 5 wt % of ABR (0.05 g) as a binder were added to heptane (0.8 g) as a solvent, and the mixture was dispersed for 10 minutes using ultrasonic waves. The obtained solid electrolyte slurry was applied to a stainless steel foil using a blade with a gap of 50 μm to prepare a solid electrolyte layer.

### Preparation of Positive Electrode

NCA (2 g) as a positive electrode active material, multi-walled carbon nanotubes (MWCNT) (0.03 g) as a conductive material, a sulfide solid electrolyte (0.3 g) as a solid electrolyte, and a diisobutyl ketone solution containing 5 wt % of PVDF-HFP (0.3 g) as a binder were added to diisobutyl ketone (1 g) as a solvent, and the mixture was dispersed for 10 minutes using ultrasonic waves. The obtained positive electrode slurry was applied onto an Al foil as a positive electrode current collector using a blade with a gap of 100 μm to prepare a positive electrode including a positive electrode layer and a positive electrode current collector.

### Preparation of Battery

The solid electrolyte layer was laminated on the negative electrode layer and roll-pressed at room temperature with a linear pressure of 3 t/cm to obtain a negative electrode-side laminate. The solid electrolyte layer was laminated on the positive electrode layer and roll-pressed at 170° C. with a linear pressure of 5 t/cm to obtain a positive electrode-side laminate.

The negative electrode-side laminate and the positive electrode-side laminate were each punched out to 1 cm², and the solid electrolyte layers were laminated and bonded to prepare a battery.

### Comparative Examples 1 to 5

Batteries were prepared in the same method as in Example 1 except that no second layer was prepared, and in [Preparation of first layer], a Ni foil was used in place of an Al foil, and in [Preparation of negative electrode], a negative electrode including a negative electrode layer with a single-layer structure and a Ni foil as a negative electrode current collector was prepared. Table 1 shows vol % of the solid electrolyte, vol % of the Si-based active material, SE/AM, and the thickness of the first layers of Comparative Examples 1 to 5.

TABLE 1

| | | | | | | Second | Second | | | Negative |
|---|---|---|---|---|---|---|---|---|---|---|
| | Negative | | First layer | First layer | Second | layer | layer | | Second | electrode |
| | electrode | First layer | SE | AM | layer | SE | AM | First layer | layer | Total |
| | layer | SE/AM | percentage | percentage | SE/AM | percentage | percentage | Thickness | Thickness | thickness |
| | Structure | — | (vol %) | (vol %) | — | (vol %) | (vol %) | (μm) | (μm) | (μm) |
| Comparative | single-layer | 0.820 | 31.4 | 38.3 | — | — | — | 40 | 0 | 40 |
| Example 1 | | | | | | | | | | |
| Comparative | single-layer | 1.000 | 35.3 | 35.3 | — | — | — | 43 | 0 | 43 |
| Example 2 | | | | | | | | | | |
| Comparative | single-layer | 1.224 | 39.3 | 32.1 | — | — | — | 48 | 0 | 48 |
| Example 3 | | | | | | | | | | |
| Comparative | single-layer | 1.498 | 43.3 | 28.9 | — | — | — | 54 | 0 | 54 |
| Example 4 | | | | | | | | | | |
| Comparative | single-layer | 1.855 | 47.5 | 25.6 | — | — | — | 70 | 0 | 70 |
| Example 5 | | | | | | | | | | |
| Comparative | two-layer | 0.820 | 31.4 | 38.3 | 0.820 | 31.4 | 38.3 | 13 | 27 | 40 |
| Example 6 | | | | | | | | | | |
| Example 1 | two-layer | 1.000 | 35.3 | 35.3 | 0.820 | 31.4 | 383 | 13 | 28 | 41 |
| Example 2 | two-layer | 1.224 | 39.3 | 32.1 | 0.820 | 31.4 | 38.3 | 13 | 29 | 42 |
| Example 3 | two-layer | 1.498 | 43.3 | 28.9 | 0.820 | 31.4 | 38.3 | 13 | 30 | 43 |
| Example 4 | two-layer | 1.855 | 47.5 | 25.6 | 0.820 | 31.4 | 38.3 | 13 | 32 | 45 |
| Comparative | two-layer | 3.005 | 56.2 | 18.7 | 0.820 | 31.4 | 38.3 | 13 | 34 | 47 |
| Example 7 | | | | | | | | | | |
| Comparative | two-layer | 8.987 | 70.1 | 7.8 | 0.820 | 31.4 | 38.3 | 13 | 37 | 50 |
| Example 8 | | | | | | | | | | |
| Example 5 | two-layer | 1.224 | 39.3 | 32.1 | 0.820 | 31.4 | 38.3 | 7 | 34 | 41 |
| Example 6 | two-layer | 1.224 | 39.3 | 32.1 | 0.820 | 31.4 | 38.3 | 20 | 24 | 44 |
| Example 7 | two-layer | 1.224 | 39.3 | 32.1 | 0.820 | 31.4 | 38.3 | 25 | 20 | 45 |
| Example 8 | two-layer | 1.498 | 43.3 | 28.9 | 0.820 | 31.4 | 38.3 | 7 | 34 | 41 |
| Example 9 | two-layer | 1.498 | 43.3 | 28.9 | 0.820 | 31.4 | 38.3 | 20 | 25 | 45 |
| Example 10 | two-layer | 1.498 | 43.3 | 28.9 | 0.820 | 31.4 | 38.3 | 25 | 22 | 47 |

### Ion Conductivity Measurement

The ion conductivity of each first layer prepared in Examples 1 to 10 and Comparative Examples 1 to 8 under predetermined conditions was calculated. The results are shown in Table 2.

The ion conductivity of each second layer prepared in Examples 1 to 10 and Comparative Examples 6 to 8 under predetermined conditions was calculated. The results are shown in Table 2.

### Battery Resistance Measurement

The resistance of each battery prepared in Examples 1 to 10 and Comparative Examples 1 to 8 under predetermined conditions was calculated according to Ohm's law. The results are shown in Table 2.

Number of Charging and Discharging Cycles Until Capacity Reached Less than 80%

The batteries prepared in Examples 1 to 10 and Comparative Examples 1 to 8 were repeatedly charged and discharged under predetermined conditions, the initial capacity of the battery was set to 100%, and the number of charging and discharging cycles from initial charging and discharging until the battery capacity reached less than 80% was measured. The results are shown in Table 2.

### Cycle Increment/Thickness Increment Relative to Comparative Example 1

The thickness increment of the negative electrode layer of Examples 1 to 10 and Comparative Examples 2 to 8 to the thickness of the negative electrode layer of Comparative Example 1 was calculated.

The increase in the number of charging and discharging cycles (cycle increment) until the capacity reached less than 80% in Examples 1 to 10 and Comparative Examples 2 to 8 relative to the number of charging and discharging cycles until the capacity reached less than 80% in Comparative Example 1 was calculated.

Then, the cycle increment/thickness increment (cycles/m) relative to Comparative Example 1 was calculated. The results are shown in Table 2.

TABLE 2

| | | | | | | Cycle |
|---|---|---|---|---|---|---|
| | | | | | Number of charging | increment thickness |
| | | | First layer-Second | | and discharging | increment relative to |
| | First layer | Second layer | layer | | cycles until capacity | Comparative Example |
| | ion conductivity | ion conductivity | ion conductivity | Cell resistance | reached less than | 1 |
| | (mS/cm) | (mS/cm) | (mS/cm) | (Ω · cm²) | 80% | (cycles/μm) |
| Comparative | 0.24 | — | — | 16.7 | 8 | — |
| Example 1 | | | | | | |
| Comparative | 0.32 | — | — | 15.4 | 16 | 2.7 |
| Example 2 | | | | | | |
| Comparative | 0.46 | — | — | 14.8 | 45 | 4.6 |
| Example 3 | | | | | | |
| Comparative | 0.67 | — | — | 14.3 | 108 | 7.1 |
| Example 4 | | | | | | |
| Comparative | 0.9 | — | — | 13.9 | 216 | 6.9 |
| Example 5 | | | | | | |
| Comparative | 0.24 | 0.24 | 0 | 23.8 | 8 | — |
| Example 6 | | | | | | |
| Example 1 | 0.32 | 0.24 | 0.08 | 20.6 | 14 | 6 |
| Example 2 | 0.46 | 0.24 | 0.22 | 18.7 | 35 | 13.5 |
| Example 3 | 0.67 | 0.24 | 0.43 | 19.9 | 79 | 23.7 |
| Example 4 | 0.9 | 0.24 | 0.66 | 20.1 | 205 | 39.4 |
| Comparative | 1.25 | 0.24 | 1.01 | 20.5 | 7 | −0.1 |
| Example 7 | | | | | | |
| Comparative | 1.4 | 0.24 | 1.16 | 19.5 | 5 | −0.3 |
| Example 8 | | | | | | |
| Example 5 | 0.32 | 0.24 | 0.08 | 22.3 | 32 | 24 |
| Example 6 | 0.32 | 0.24 | 0.08 | 19 | 40 | 8 |
| Example 7 | 0.32 | 0.24 | 0.08 | 20.4 | 43 | 7 |
| Example 8 | 0.67 | 0.24 | 0.43 | 19.1 | 65 | 57 |
| Example 9 | 0.67 | 0.24 | 0.43 | 20.5 | 195 | 37.4 |
| Example 10 | 0.67 | 0.24 | 0.43 | 19.6 | 234 | 32.3 |

As shown in Table 2, it can be understood that, in Comparative Example 1 and Comparative Example 6, the negative electrode layers had different structures such as a single-layer structure and a two-layer structure, but the total thickness of the negative electrode layer was the same, and thus no improvement in the cycle characteristics of the battery was observed, and the resistance increased in the case of a two-layer structure.

It can be understood that the thickness of the negative electrode layer could be reduced and the cycle characteristics of the battery could be improved in Example 1 compared to Comparative Example 2, in Example 2 compared to Comparative Example 3, in Example 3 compared to Comparative Example 4, and in Example 4 compared to Comparative Example 5.

It can be understood that, comparing Examples 1 to 4 with Comparative Examples 6 to 8, when the value obtained by subtracting the ion conductivity of the second layer from the ion conductivity of the first layer was 0.08 mS/cm or more, and the percentage of the solid electrolyte in the first layer was 47.5 vol % or less, the cycle characteristics of the battery could be improved.

It can be understood that, comparing Examples 2, and 5 to 7, and comparing Examples 3, and 8 to 10, those having a smaller thickness of the first layer could improve the cycle characteristics of the battery.

What is claimed is:

1. A battery comprising a positive electrode current collector, a positive electrode layer, an electrolyte layer, a negative electrode layer, and a negative electrode current collector in that order,
wherein the negative electrode layer includes a first layer disposed on the side of the electrolyte layer in a thickness direction and a second layer disposed on the side of the negative electrode current collector in the thickness direction relative to the first layer,
wherein the first layer and the second layer each contain a Si-based active material and a solid electrolyte as a negative electrode active material,
wherein the value obtained by subtracting the ion conductivity of the second layer from the ion conductivity of the first layer is 0.08 mS/cm or more, and
wherein the percentage of the solid electrolyte in the first layer is 47.5 vol % or less.

2. The battery according to claim 1,
wherein the percentage of the solid electrolyte in the first layer is 35.3 vol % or more.

3. The battery according to claim 1,
wherein the Si-based active material is porous.

4. The battery according to claim 1,
wherein the volume ratio (SE/AM) of the solid electrolyte to the negative electrode active material in the first layer is larger than the volume ratio (SE/AM) of the solid electrolyte to the negative electrode active material in the second layer.

5. The battery according to claim 1,
wherein the thickness of the first layer is 7 to 25 μm, and
wherein the thickness of the negative electrode layer is 40 μm or more.
